(19) United States
(12) Patent Application Publication
(10) Pub. No.: US 2008/0057788 A1
(43) Pub. Date: Mar. 6, 2008

(54) METHODS AND APPARATUS FOR TERMINATING A SHIELDED CABLE

(75) Inventors: DON A. GILLILAND, ROCHESTER, MN (US); DENNIS J. WURTH, ROCHESTER, MN (US)

Correspondence Address: IBM CORPORATION, INTELLECTUAL PROPERTY LAW, DEPT 917, 3605 HIGHWAY 52 NORTH, ROCHESTER, MN, 55901-7829, US

(73) Assignee: IBM

(21) Appl. No.: 11/928,854

(22) Filed: Oct. 30, 2007

Related U.S. Application Data
(62) Division of application No. 11/154,910, filed on Jun. 16, 2005.

(51) Int. Cl. H01R 9/03

(52) U.S. Cl. 439/610

(57) ABSTRACT

In a first aspect, a method is provided for terminating a shield of a cable. The method includes the steps of (1) exposing a periphery region of the shield along a first portion of the cable; (2) coupling an electrically-conductive housing including an electrically-conductive gasket around the exposed periphery region; (3) applying a force to and maintaining the force on the gasket such that the gasket is forced against and remains in contact with an interior region of the housing and the exposed periphery region of the shield; and (4) coupling an exterior region of the housing to an electrically-conductive enclosure of an electronic product to which the cable is coupled. Numerous other aspects are provided.

The present application is a division of and claims priority to U.S. patent application Ser. No. 11/154,910, filed Jun. 16, 2005, which is hereby incorporated by reference herein its entirety.

### FIELD OF THE INVENTION

The present invention relates generally to electronic products, and more particularly to methods and apparatus for terminating a shielded cable employed with electronic products.

### BACKGROUND

Typically, a shield of a cable coupled to an electronic product requiring electromagnetic compatibility (EMC) treatment (e.g., certification) may be terminated using a shielded connector. The shield of the cable may be terminated by forming a connection, having an impedance, between the shield and an enclosure of the electronic product using the shielded connector. However, to terminate the cable shield, the shielded connector forms multiple interfaces between one or more components of the cable and/or the electronic product enclosure. Each of the multiple interfaces is not adjustable. Further, each of the multiple interfaces may introduce shielding imperfections. Therefore, the effectiveness of cable shielding may vary as the cable is moved and/or attached or detached from the electronic product. Consequently, improved methods and apparatus for terminating the shield of a cable are desired.

### SUMMARY OF THE INVENTION

In a first aspect of the invention, a method is provided for terminating a shield of a cable. The method includes the steps of (1) exposing a periphery region of the shield along a first portion of the cable; (2) coupling an electrically-conductive housing including an electrically-conductive gasket around the exposed periphery region; (3) applying a force to and maintaining the force on the gasket such that the gasket is forced against and remains in contact with an interior region of the housing and the exposed periphery region of the shield; and (4) coupling an exterior region of the housing to an electrically-conductive enclosure of an electronic product to which the cable is coupled.

In a second aspect of the invention, an apparatus for terminating a shield of a cable is provided. The first apparatus includes (1) an electrically-conductive housing including an interior region adapted to couple to an exposed periphery region of the shield and an exterior region adapted to couple to an enclosure of an electronic product to which the cable is coupled; (2) an electrically-conductive gasket inside the housing adapted to couple the exposed periphery region of the shield to an interior region of the housing; and (3) an adjustment mechanism adapted to apply a force to and maintain the force on the gasket such that the gasket is forced against and remains in contact with the interior region of the housing and the exposed periphery region of the shield.

In a third aspect of the invention, a system for terminating a shield of a cable is provided. The system includes (1) an enclosure of an electronic product to which the cable couples; and (2) a termination apparatus coupled to the enclosure and having (a) an electrically-conductive housing including an interior region adapted to couple to an exposed periphery region of the shield and an exterior region adapted to couple to the enclosure of the electronic product to which the cable couples; (b) an electrically-conductive gasket inside the housing adapted to couple the exposed periphery region of the shield to an interior region of the housing; and (c) an adjustment mechanism adapted to apply a force to and maintain the force on the gasket such that the gasket is forced against and remains in contact with the interior region of the housing and the exposed periphery region of the shield. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a cross-sectional schematic view of an apparatus for terminating a shield of a cable in accordance with an embodiment of the present invention.

FIG. 2 is an isometric view of the apparatus for terminating a shield of a cable in accordance with an embodiment of the present invention.

FIG. 3 is a side schematic view of the apparatus for terminating a shield of a cable in accordance with an embodiment of the present invention.

FIG. 4 is an isometric view of a system for terminating a shield of a cable in accordance with an embodiment of the present invention.

FIG. 5 is an isometric view of a slot of the electronic device enclosure and a corresponding sleeve in accordance with an embodiment of the present invention.

FIG. 6 is another isometric view of the sleeve in accordance with an embodiment of the present invention.

FIG. 7 is an isometric view of an alternative electronic device enclosure included in a system for terminating a shield of a cable in accordance with an embodiment of the present invention.

### DETAILED DESCRIPTION

The present invention provides improved methods and apparatus for terminating a cable shield. The present method employs a termination apparatus that uses compression to couple (e.g., connect) a shield of a cable to an electronic product enclosure. In this manner, the present invention may avoid the shielding imperfections described above. The connection formed between the cable shield and electronic product enclosure via the inventive termination apparatus has an impedance. However, the inventive termination apparatus is adapted to adjust the compression applied to the cable shield, and thereby adjust the impedance of the cable shield termination. Consequently, the termination impedance may be adjusted based on a frequency of a signal to be transmitted by the cable. Further, the inventive termination apparatus may couple to the shield of the cable along any portion of the cable. Therefore, a desired length of the cable may enter the electronic product enclosure for coupling to internal circuitry. Consequently, the present invention does not require the interface between the cable and internal circuitry of the electronic product to be at the enclosure. In this manner, the present invention provides improved methods and apparatus for terminating a cable shield.

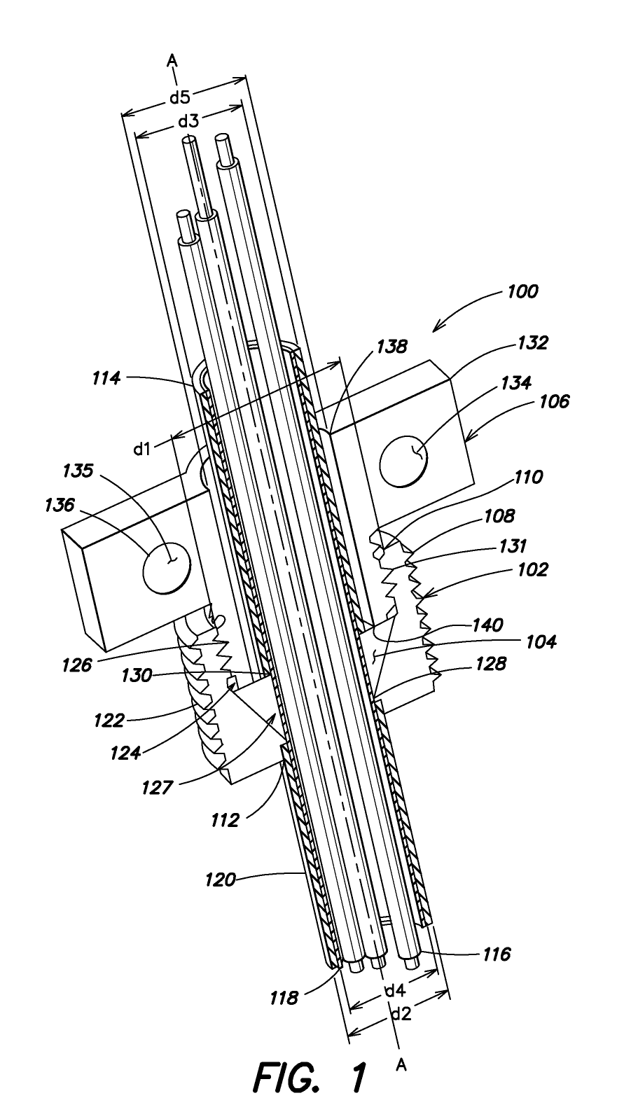

FIG. 1 is a cross-sectional schematic view of an apparatus for terminating a shield of a cable in accordance with an embodiment of the present invention. With reference to FIG. 1, the terminating apparatus 100 may include a housing 102 adapted to couple to a gasket 104 and an adjustment mechanism 106 (e.g., a handle or another suitable adjustment mechanism). The housing 102 may be a multi-piece assembly (although the housing 102 may be a single piece). For example, the housing 102 may be a two-piece split-collar assembly including a first piece 108 and a second piece (not shown in FIG. 1). In this manner, when assembled, the housing 102 may form a first opening 110 of diameter d1 and a second opening 112 of diameter d2. The diameters d1, d2 of the housing openings 110, 112 may be selected based on a diameter d3 of a cable 114 around which the housing 102 will couple. In some embodiments, the diameter d3 of the cable 114 is ½ inch (although a larger or smaller diameter may be employed). The cable 114 may include one or more wires 116 surrounded by a shield 118. Further, the shield 118 may be surrounded by insulation 120.

An exterior region of the housing 102 may include threads 122 or another suitable feature adapted to couple (e.g., fixedly) to an enclosure of an electronic product to which the cable couples. Further, an interior region 124 of the housing 102 may include threads 126 or another suitable feature adapted to couple (e.g., fixedly) to the adjustment mechanism 106. Further, the interior region 124 of the housing 102 may be shaped to accommodate the gasket 104 (described in detail below). The housing 102 may be formed from metal, electrically-conductive plastic or another suitable material.

The gasket 104 may couple to the interior region 124 of the housing 102. The gasket 104 may be adapted to couple to and/or around an exposed portion 127 (e.g., a periphery region) of the shield 118 that may be along any portion of the cable 114. The gasket 104 may form first and second openings 128, 130 of diameter d4. The diameter d4 of the first and second openings 128, 130 may be based on the diameter d3 of the cable 114 to which the termination apparatus 100 is to couple. Although the diameter d4 of the first and second openings 128, 130 of the gasket 104 are the same, in some embodiments, the diameter of the first opening 128 may be different than the diameter of the second opening 130.

In some embodiments, the gasket 104 may be a multi-piece gasket such as a split collar. Alternatively, the gasket 104 may be a single piece such as a split ring. In this manner, the gasket 104 may fit around the cable 114 without requiring an end of the cable 114 to pass through the gasket 114. Consequently, the gasket 104 may be coupled to the cable 114 without requiring either end of the cable 114 to be disconnected. In some embodiments, the gasket 104 may be tapered (although the gasket 104 may be shaped differently). The gasket 104 may be formed from an electrically-conductive material (e.g., a silver-impregnated elastomer).

For example, in some embodiments, the gasket 104 may be a tapered split-collar gasket. The split-collar tapered gasket may be formed from a rigid, conductive plated metal, conductive unplated metal or conductive plastic (e.g., copper, nickel-plated steel, stainless steel, etc.). Alternatively, the gasket 104 may be a tapered split-ring gasket. The tapered split-ring gasket may be formed from a flexible conductive material, such as Ultra Vanshield EMI/RFI Shielding manufactured by Vanguard Products Corporation of Danbury, Conn., or another suitable material.

Alternatively, in some embodiments, the gasket 104 may be formed from a conductive packing. For example, the gasket 104 may be formed from packed conductive wool, such as bronze wool, steel wool, copper wool or the like. As a further alternative, in some embodiments, the gasket 104 may be formed from a conductive fabric (e.g., a nickel-plated fabric, silver-plated fabric, etc.) over foam.

The adjustment mechanism 106 of the termination apparatus 100 may be adapted to couple to the interior region 124 of the housing 102. More specifically, the adjustment mechanism 106 may be adapted to apply and maintain a force on the gasket 104 such that the gasket is forced against and remains in contact with (1) an exposed portion 127 of the shield 118 of the cable 114 around which the gasket 104 is coupled; and (2) a portion of the interior region 124 of the housing 102. An exterior region of the adjustment mechanism 106 may include threads 131 or another suitable feature adapted to couple (e.g., fixedly) to the housing 102. More specifically, threads 131 of the adjustment mechanism 106 may be adapted to mate with threads 126 along an interior region 124 of the housing 102. Therefore, as the adjustment mechanism 106 is rotated in a first rotation direction (e.g., about a longitudinal axis A-A of the adjustment mechanism 106), the adjustment mechanism 106 may be screwed into the housing 102. As the adjustment mechanism 106 is rotated in the first direction, the adjustment mechanism 106 eventually contacts the gasket 104. As the adjustment mechanism 106 is further rotated in the first direction, the adjustment mechanism 106 may increasingly apply a force (e.g., in a first direction) to the gasket 104. Consequently, a force is applied on the gasket 104 in a second direction such that the gasket 104 is forced toward the exposed portion 127 of the shield 118 and in a third (e.g., opposite) direction such that the gasket 104 is forced toward the interior region 124 of the housing 102. Alternatively, as the adjustment mechanism 106 is rotated in a second, opposite rotation direction (e.g., about the longitudinal axis A-A of the adjustment mechanism 106), the adjustment mechanism 106 may be unscrewed from the housing 102. If the adjustment mechanism 106 is contacting the gasket 104, as the adjustment mechanism 102 is rotated in the second direction, the force applied to the gasket 104 by the adjustment mechanism 106 may decrease.

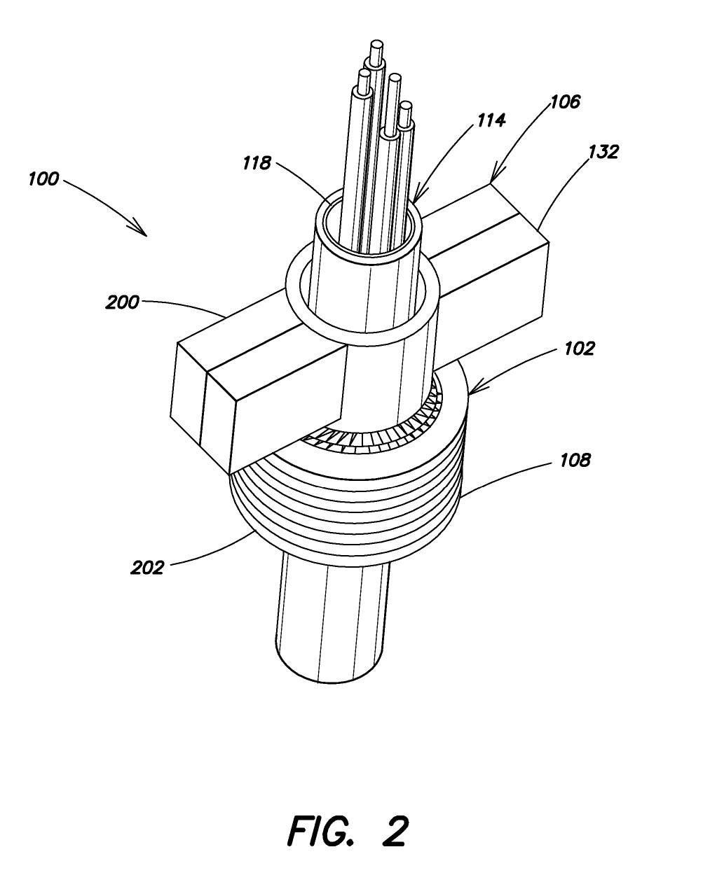

In some embodiments, the adjustment mechanism 106 may be a multi-piece adjustment mechanism (although the adjustment mechanism 106 may be a single piece). For example, the adjustment mechanism 106 may include a first piece 132 and a second piece (not shown in FIG. 1; 200 in FIG. 2). The first piece 132 may include an alignment feature 134, such as a pin, adapted to couple to a corresponding feature, such as a slot, in the second piece. Similarly, the second piece may include an alignment feature 135 (e.g., pin) adapted to couple to a corresponding feature 136 (e.g., slot) of the first piece 132. In this manner, the alignment features 134, 135 and corresponding features 136 may ensure proper assembly of the multi-piece adjustment mechanism 106 (e.g., of the first and second pieces 132, 200 of the adjustment mechanism 106).

The adjustment mechanism 106 may form first and second openings 138, 140 of diameter d5. The diameter d5 of the first and second openings 138, 140 may be based on diameter of the cable 114 to which the termination apparatus 100 is to couple. Although the diameter d5 of the first and second openings 138, 140 of the adjustment mechanism 106 are the same, in some embodiments, the diameter of the first opening 138 may be different than the diameter of the second opening 140.

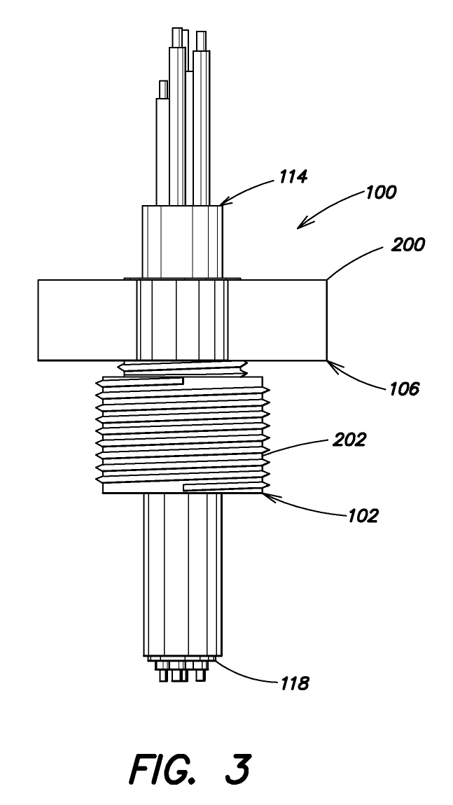

FIGS. 2 and 3 are an isometric view and a side view, respectively, of the apparatus 100 for terminating a shield 118 of a cable 114 in accordance with an embodiment of the present invention. With reference to FIG. 2, the first and second pieces 132, 200 of the adjustment mechanism 106 are coupled together thereby assembling the adjustment mechanism 106 around the cable 114. Additionally, the adjustment mechanism 106 is coupled (e.g., fixedly) to the housing 102, which may be formed by the first and a second piece 108, 202.

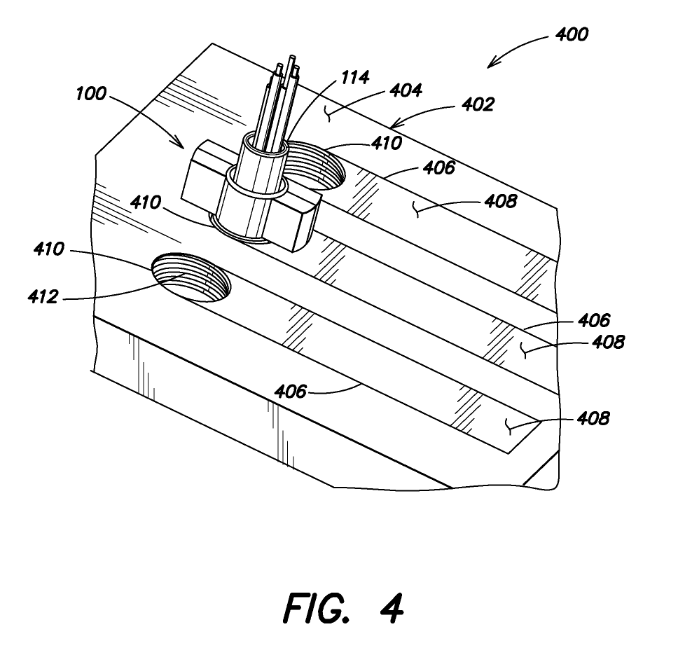

FIG. 4 is an isometric view of a system for terminating a shield of a cable in accordance with an embodiment of the present invention. With reference to FIG. 4, the system 400 may include the apparatus 100 for terminating a shield of a cable coupled to an enclosure 402 (a portion 404 of which is shown) of an electronic product to which the cable 114 couples. The enclosure 402 may include one or more slots 406 adapted to couple to corresponding sleeves 408. As shown, when a sleeve 408 is inserted into a slot 406, the combination of the sleeve 408 and slot 406 may form an opening 410 adapted to couple to the housing (not shown in FIG. 4; 102 in FIG. 3). More specifically, the opening 410 may include threads 412 or another suitable feature adapted to mate with corresponding features (e.g., threads 122) on an exterior region of the housing 102, thereby coupling (e.g., fixedly) the apparatus 100 to the enclosure 402.

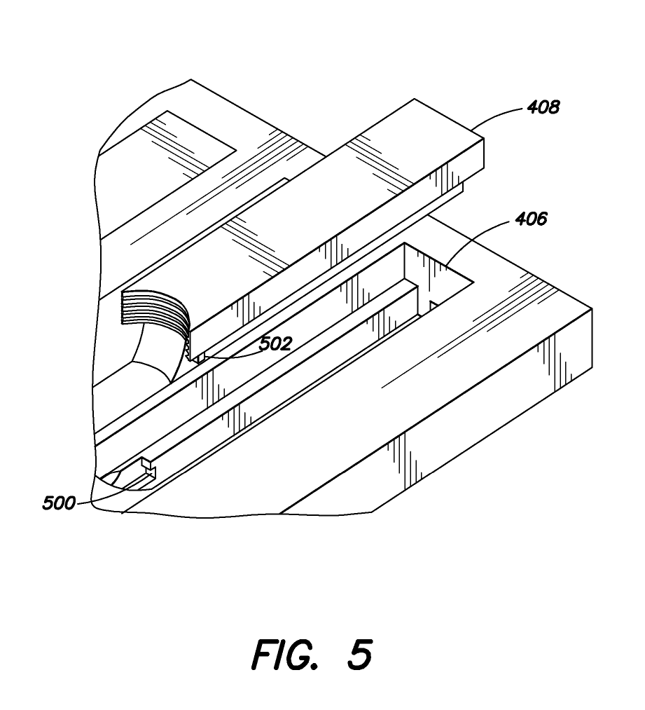

In some embodiments, the enclosure 402 may be formed from metal, conductive plastic or another suitable material. Further, in some embodiments, the sleeve 408 may be formed from metal, conductive plastic or another suitable material. However, the enclosure 402 and/or the sleeve 408 may be formed from different and/or additional materials. Additional details of the one or more slots 406 and/or the corresponding sleeves 408 are described below with reference to FIGS. 5-7.

FIG. 5 is an isometric view of a slot of the electronic device enclosure and a corresponding sleeve in accordance with an embodiment of the present invention. With reference to FIG. 5, the slot 406 may predominantly have a rectangular volume (although the slot 406 may be shaped differently). More specifically, the slot 406 may have an elongated rectangular volume, a portion of which has been modified to form a portion of the opening (410 in FIG. 4). The slot 406 may define a closed perimeter such that a corresponding sleeve 408 may be dropped into the slot 406. The slot 406 may be dimensioned such that a cable 114 with the apparatus 100 coupled thereto may pass through the slot 406. In this manner, the portion of the cable 114 with the apparatus 100 coupled thereto may be inserted into the enclosure 400. In some embodiments, the cable 114 with the apparatus 100 coupled thereto may also have a connector (not shown) coupled thereto. The connector may be adapted to couple to the circuit board, a cable within the electronic product enclosure 400 or another device within the electronic product enclosure 400. In such embodiments, the slot may be dimensioned such that a cable 114 with the apparatus 100 and connector coupled thereto may pass through the slot 406. The slot 406 may include one or more features such as notches 500 adapted to couple to corresponding features of the sleeve 408 (described below). The notches 500 of the slot 406 may be positioned as desired.

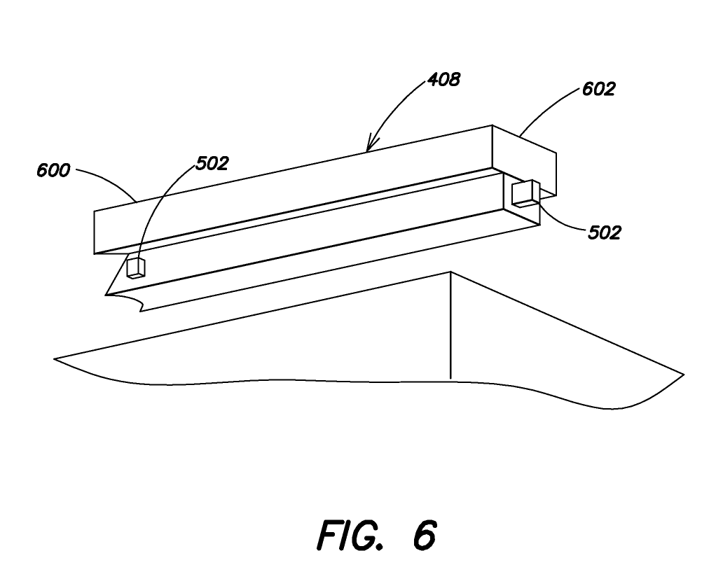

In such embodiments, the sleeve 408 may be predominately shaped like an elongated rectangular block (although the sleeve 408 may be shaped differently). More specifically, the sleeve 408 may be shaped like a rectangular block a portion of which has been modified to form a portion of the opening 410. The sleeve 408 may include one or more features such as mechanical stops 502 adapted to couple to corresponding notches 500 of the slot 406 to which the sleeve 408 couples. In this manner, the one or more mechanical stops 502 may align the sleeve 408 in the slot 406 and/or limit movement of the sleeve 408 in the slot 406. FIG. 6 is another isometric view of the sleeve 408 in accordance with an embodiment of the present invention. With reference to FIG. 6, the sleeve 408 may include one or more mechanical stops 502 adjacent a first end 600 of the sleeve 408 modified to form a portion of the opening 410. Further, the sleeve 408 may include one or more mechanical stops 502 on a second end 602 of the sleeve 408 (e.g., opposite the first end 600).

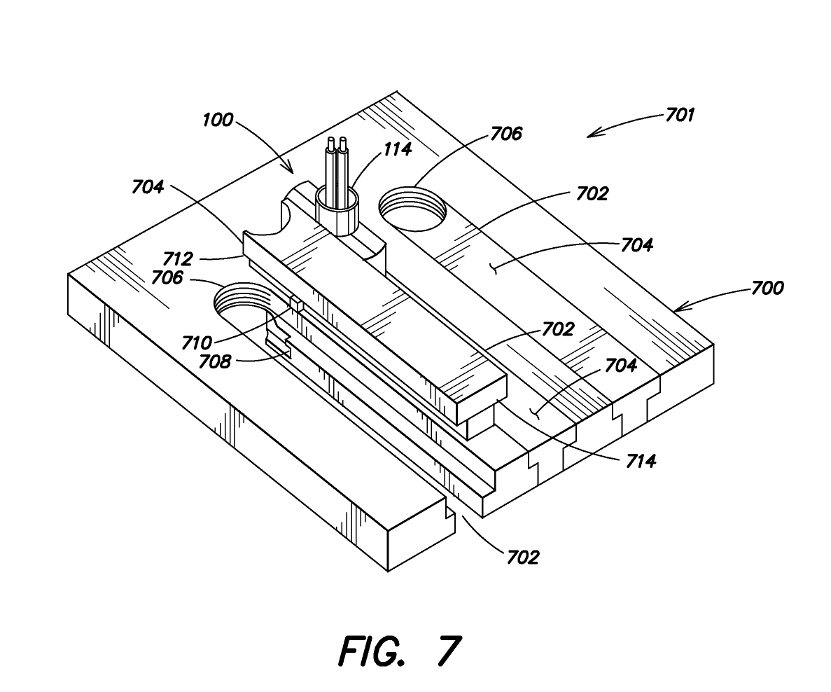

FIG. 7 is an isometric view of an alternative electronic device enclosure 700 included in a system 701 for terminating a shield of a cable in accordance with an embodiment of the present invention. With reference to FIG. 7, the alternative enclosure 700 may be similar to the enclosure 400 described with reference to FIG. 4. For example, the enclosure 700 may include one or more slots 702 adapted to couple to corresponding sleeves 704. As shown, when a sleeve 704 is inserted into a slot 702, the combination of the sleeve 704 and slot 702 may form an opening 706 adapted to couple to the housing (not shown in FIG. 7; 102 in FIG. 3). However, in contrast to the slot 406 in the enclosure 402 described with reference to FIG. 4, the slot 702 is designed so that the sleeve 704 may slide into the slot 702. For example, the slot 702 may not have a closed perimeter.

Further, similar to the slot 406, the slot 702 may include one or more notches 708 adapted to couple to corresponding features of the sleeve 704. The notches 708 of the slot 702 may be positioned as desired. The sleeve 704 may include one or more features such as mechanical stops 710 adapted to couple to corresponding notches 708 of the slot 702 to which the sleeve 704 couples. In this manner, the one or more mechanical stops 710 may align the sleeve 704 in the slot 702 and/or limit movement of the sleeve 704 in the slot 702. The position of the mechanical stops 710 on the sleeve 704 may be similar to the position of the mechanical stops 502 of the sleeve 408 described with reference to FIGS. 4-6. For example, the sleeve 704 may include one or more mechanical stops 710 adjacent a first end 712 of the sleeve 704 that is modified to form a portion of the opening 706. However, in contrast to sleeve 408, sleeve 704 may not include a mechanical stop 710 on a second end 714 of the sleeve 704 (e.g., opposite the first end 712). The slot 702 may be dimensioned such that a cable 114 with the apparatus 100 coupled thereto may pass through the slot 702. Alternatively or additionally, the slot 702 may be dimensioned such that a cable 114 may slide through the slot 702. The cable 114 may have the apparatus 100 coupled thereto. In this manner, the portion of the cable 114 with the apparatus 100 coupled thereto may be inserted into the enclosure 700.

A cable 114 that couples to an electronic product requiring electromagnetic compatibility (EMC) treatment (e.g., certification) may require termination. Termination may prevent unwanted noise (e.g., microwave and/or radio-frequency waves) from affecting signals transmitted on one or more wires 116 included in the cable 114. The present invention may provide termination of the cable without the disadvantages of using a shielded connector described above. Consequently, the operation of the system 400, 701 for terminating a shield of a cable is now described with reference to FIGS. 1-7. A periphery region of the shield 118 of a portion (e.g., non-end portion) of a cable 114 may be exposed (e.g., by stripping insulation 120 adjacent thereto). The housing 102 including the gasket 104 may be coupled around the exposed portion of the shield 118. Further, the adjustment mechanism 106 may be coupled around the cable 114. The cable shield termination apparatus 100 along with the cable 114 coupled thereto may be inserted within an enclosure 402, 700 of the electronic product. For example, the apparatus 100 along with the cable 114 coupled thereto may be inserted through a slot 406. A corresponding sleeve 408 may be dropped into the slot 406, thereby forming an opening 410. Alternatively, a portion of the cable 114 may be slid along a slot 702 having an open perimeter such that the apparatus 100 and cable 114 coupled thereto may enter enclosure 402, 700. A corresponding sleeve 704 may slide into the slot 702, thereby forming an opening 706.

The housing 102 may be coupled (e.g., fixedly) to the opening 410, 706 of the enclosure 402, 700. For example, the housing 102 may be screwed into the opening 410, 706. As the housing 102 is coupled to the opening 410, 706, mechanical stops 502, 710 of the sleeve 408, 704 make contact with (e.g., engage) corresponding notches 500, 708, thereby securing the sleeve 408, 704 in the slot 406, 702 and securing the apparatus 100 in the opening 410, 706.

By rotating the adjustment mechanism 106 in the first rotation direction, the adjustment mechanism 106 may be coupled to the housing 102. Further, the adjustment mechanism 106 may contact the gasket 104 inside the housing 102. Therefore, the adjustment mechanism 106 may apply a force in a first direction (e.g., along a longitudinal axis A-A of the adjustment mechanism 106). Consequently, a force in a second direction (e.g., towards a center of the housing 102) and a force in a third direction (e.g., away from a center of the housing 102) may be applied to the gasket 104. Such forces may compress the gasket 104. In this manner, the gasket 104 may be forced against the exposed region of the shield 118 and the interior region 124 of the housing 102. The adjustment mechanism 106 may maintain the force applied in the first direction on the gasket 104, and therefore, maintain the force applied in the second and third directions on the gasket 104. Therefore, the gasket 104 remains in contact (e.g., electrical contact) with the shield 118 and housing 102. Once the exterior region of the housing 102 is coupled to the enclosure 402, 700, the shield 118 of the cable 114 is electrically coupled to the enclosure 402, 700, and therefore, terminated. The impedance of the connection between the shield 118 and enclosure 402, 700 is based on the force applied to the shield 118 (e.g., by the gasket). By maintaining a force (e.g., compression) on the shield 118, the present methods and apparatus may control the impedance of the connection between the shield 118 and enclosure 402, 700.

Further, by rotating the adjustment mechanism 106 and thereby adjusting the force applied in the first direction to the gasket 104, the force (e.g., compression) applied by the gasket 104 to the shield 118 may be adjusted. Consequently, the impedance of the termination may be adjusted. Impedance adjustability provides benefits. For example, adjusting impedance of the connection based on signals (e.g., frequency of such signals) to be transmitted on wires 116 of the cable 114 may improve termination and shielding effectiveness.

In contrast to a shielded connector, the apparatus 100 may not be required to couple an end of the cable 114 to terminate that cable 114. Therefore, the interface between exterior portions of the cable 114 (e.g., the insulator 120 and shield 118) and the electronic product is not limited to the enclosure 402, 700 of the electronic product to which the cable 114 couples. Rather, a portion (e.g., a desired length) of the entire cable 114 may enter the enclosure 402, 700 and extend to a portion of a circuit board to which the cable 114 is to couple. In this manner, wires 116 included in the cable 114 may couple to internal circuitry of the electronic product. Enabling a portion of the entire cable 114 to enter the enclosure 402, 700 and extend to the portion of the circuit board where wires 116 of the cable 114 couple to circuitry of the board may be useful in maintaining signal integrity.

Through use of the present methods and apparatus, termination of a shield of a cable to an enclosure of an electronic device may be improved. For example, the present methods and apparatus may provide a more stable termination connection than a shielded connector by employing a compression gasket to ensure connection between the shield of the cable and the enclosure of the electronic product. Further, the present methods and apparatus enable termination of a cable 114 without disconnecting either end of the cable 114 and adjustment of an impedance of the termination connection. Additionally, the present methods and apparatus do not limit the interface between exterior portions of the cable 114 and the electronic product to which the cable 114 couples to the enclosure 402, 700 of the electronic product.

The foregoing description discloses only exemplary embodiments of the invention. Modifications of the above disclosed apparatus and methods which fall within the scope of the invention will be readily apparent to those of ordinary skill in the art. For instance, although in embodiments above, the housing 102 and enclosure 402, 700 are designed such that the housing 102 of the apparatus 100 couples to an interior surface of the enclosure 402, 700, in other embodiments, the housing 102 and enclosure 402, 700 may be designed such that the housing 102 of the apparatus 100 couples to an exterior surface of the enclosure 402, 700. Further, in some embodiments, materials for one or more components of the system 400, 701 may be selected to avoid a galvanic response in the presence of an electrolyte, thereby avoiding corrosion. In some embodiments, the diameter d5 of the first and/or second openings 138, 140 may be larger (e.g., much larger) than the diameter d3 of the cable 114. In such embodiments, a reduction collar (e.g., a hollow cylinder) may be inserted between the adjustment mechanism 106 and the cable 114 to prevent unnecessary movement of the cable 114.

Accordingly, while the present invention has been disclosed in connection with exemplary embodiments thereof, it should be understood that other embodiments may fall within the spirit and scope of the invention, as defined by the following claims.

The invention claimed is:

1. A method of terminating a shield of a cable, comprising:
exposing a periphery region of the shield along a first portion of the cable;
coupling an electrically-conductive housing including an electrically-conductive gasket around the exposed periphery region;
applying a force to and maintaining the force on the gasket such that the gasket is forced against and remains in contact with an interior region of the housing and the exposed periphery region of the shield; and
coupling an exterior region of the housing to an electrically-conductive enclosure of an electronic product to which the cable is coupled.

2. The method of claim 1 wherein applying a force to and maintaining the force on the gasket such that the gasket is forced against and remains in contact with an interior region of the housing and the exposed periphery region of the shield includes applying a force to and maintaining the force on the gasket such that the gasket compresses the shield.

3. The method of claim 1 further comprising:
inserting a second portion of the cable into the electronic product enclosure; and
coupling one or more wires included in the cable to circuitry within the electronic product.

4. The method of claim 1 further comprising adjusting compression of the shield based on one or more signals to be transmitted on the cable.

5. The method of claim 4 wherein adjusting compression of the shield based on one or more signals to be transmitted on the cable includes adjusting the force applied to and maintained on the gasket.

6. The method of claim 1 wherein coupling an exterior region of the housing to an electrically-conductive enclosure of an electronic product to which the cable is coupled includes fixedly coupling the exterior region of the housing to the electrically-conductive enclosure of the electronic product to which the cable is coupled.

7. The method of claim 1 wherein applying a force to and maintaining the force on the gasket such that the gasket is forced against and remains in contact with an interior region of the housing and the exposed periphery region of the shield includes applying a force in a first direction to and maintaining the force in the first direction on the gasket such that the gasket is forced in a second direction against an interior region of the housing and in a third direction against the exposed periphery region of the shield.
